(19) United States
(12) Patent Application Publication
(10) Pub. No.: US 2002/0086077 A1
(43) Pub. Date: Jul. 4, 2002

(54) Device for extruding plastic compounds

(76) Inventors: Markus Noller, Leingarten (DE); Frank Altvater, Heilbronn (DE); Gerhard Stadler, Nordheim (DE)

Correspondence Address: Clifford W. Browning, Woodard, Emhardt, Naughton, Moriarty & McNett, Bank One Center/Tower, 111 Monument Circle, Ste 3700, Indianapolis, IN, 46204-5137, US

(21) Appl. No.: 10/055,049

(22) Filed: Jan. 23, 2002

Related U.S. Application Data
(63) Continuation of application No. PCT/EP00/07550, filed on Aug. 3, 2000.

(30) Foreign Application Priority Data
Aug. 5, 1999 (DE) 199 36 827.9

(51) Int. Cl. B29C 47/92; B29C 47/24

(52) U.S. Cl. 425/145; 425/149; 425/382.3

(57) ABSTRACT

The device (10) has at least one feed instrument (12) for feeding a compound through a channel (24a; 24b; 24c) to a die (14). In order to prevent damage or destruction of the extruded compound during processing and to detect “overageing” of the compound, a sensing instrument (60a; 60b; 60c) is provided at the channel (24a; 24b; 24c) or at the die (14) in order to determine at least one measured variable (Pₐ; P_{b}; P_{c}) related to the viscosity of the compound. The feed instrument (12) and the die (14) are configured in such a way that the feed instrument (12) has a delivery pressure which oscillates over time at a frequency, and the die (14) has a flow resistance which oscillates at the same frequency.

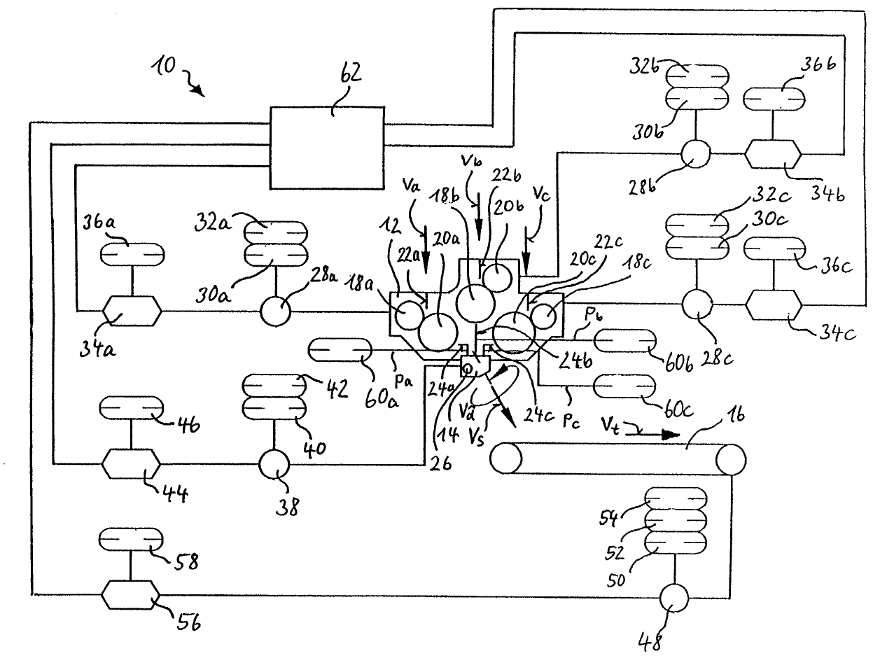

The invention relates to a device for extruding plastic compounds having the features mentioned in the precharacterising clause of claim 1.

Bakery and confectionery products are often produced by extruding a plastic dough compound or sugar/fat compound. In this case, the pressurised compound is extruded through a die to form an extrudate. The extrudate itself may be cut and/or removed by a conveyor belt. The external form of the extrudate depends on the shape of the die and, in particular, on the exit velocity of the compound from the die. If the exit velocity of the compound fluctuates, then the cut extrudate sections will differ in length, or the extrudate on the conveyor belt removing it will be formed with a non-uniform thickness.

DE-A-44 33 593 discloses a process for controlling an extruder for foodstuffs, in which a viscosity sensor, which determines measured variables such as the product temperature, the pressure in front of the die, the specific mechanical energy input, in particular the viscous properties, and optionally also the dwelling time, is installed between a worm tip and a die. The aim of the process is to optimise and stabilise the working point of the extruder. To that end, the rotational speed, the mass flow rate and the water content are mentioned as manipulated variables. In order to find the optimum working point, functional relationships between the manipulated variables and product criteria, such as colour, solubility or degree of expansion, are firstly determined by running various configurations on the extruder. Three further control stages are subsequently carried out by using the measured variables of the viscosity sensor.

WO 89/04610 discloses a process and an installation for making dough, in which a whirling mixer intimately mixes dry components with water and sends them in free fall directly to a kneading device. The kneading device delivers shaped crumbly dough uniformly to two press screws, the feed to the individual press screws being controlled, in each case on the basis of the motor power consumption, as a function of the pressure in a press head. In order to prevent stagnation of crumbly dough in front of the press screws, the latter have a higher delivery power than the kneading device. So that no air inclusions occur in the press screw, a vacuum space needs to be arranged between the kneading device and the press screw.

DE-A-22 15 449 and DE-A-43 14 728 each disclose a roller press for extruding plastic compounds with two counterrotatable rollers. The rollers have delivery strips, which revolve with the rollers and deliver the compound into a pressure chamber. The compound is separated from the rollers at a respective stripper and flows out of the pressure chamber to exit dies. Such a roller press delivers the plastic compounds in pulses, since the compound is delivered more strongly by the delivery strips than in the spaces between two delivery strips. The pulsating delivery leads to a fluctuating exit velocity of the compound from the exit dies.

The term “dough compound” means a mixture of different baking substances. These react with one another in the course of time, so that the dough compound can no longer be properly baked. This is referred to as “overageing” of the dough compound. A dough compound can therefore be processed only up to a certain time after mixing.

Furthermore, when a dough compound is being processed, it is important that it should not be exposed to any large shear forces. Large shear forces break the adhesion of the substances to one another, and individual substances, for example yeast cultures, become damaged. The composition of the dough compound is therefore destroyed.

In a sugar/fat compound, large shear forces in the compound can lead to the segregation of fat. The composition of the sugar/fat compound is therefore likewise destroyed. The desired confectionery product can then no longer be produced.

It is an object of the invention to provide a device for extruding plastic compounds, in which the aforementioned disadvantages are avoided.

The object is achieved according to the invention by a device having the features of claim 1.

For the extrusion of dough or sugar/fat compounds, roller presses are used which, owing to their design, provide an oscillating delivery pressure. Furthermore, in the case of rotatable dies, an oscillating fluctuation of the flow resistance of the compound in the die also occurs. According to the invention, the two oscillating quantities are adapted to one another in such a way as to produce a substantially constant exit flow rate of the compound from the die. Alternatively, in the case of a non-rotating die, an instrument may be provided which adapts the flow resistance of the die to the fluctuating delivery pressure of the feed instrument, so that a substantially constant exit flow rate of the compound is likewise achieved.

Dough compound is an elastoviscous compound (Maxwell medium) which may be both viscous (Newtonian fluid) and elastic (elastic body) . The viscous dough compound hence solidifies, for example, during baking, which is of course desired. Furthermore, however, the dough compound also solidifies during the processing time. From the consistency or viscosity of the dough compound, it is therefore possible to deduce whether the dough compound can, or should, continue to be processed. By virtue of the sensing instrument of the device according to the invention, it is therefore readily possible to detect whether a dough compound in the extrusion device is “overaged”. Previously, this was not detected until at a downstream oven, so that fairly large amounts of waste were produced in the meantime.

The fat contained in a sugar/fat compound is a so-called non-Newtonian substance, i.e. it does not behave as a viscous compound. If the composition of the viscous sugar/fat compound is destroyed by large shear forces, fat is separated and the viscosity of the compound hence changes. Therefore, during the processing of a sugar/fat compound, it is also possible to detect, using the sensing instrument of the device according to the invention, whether the sugar/fat compound has the required composition.

According to an advantageous refinement of the device, the measured variable is the pressure of the compound. The following will be given as an explanation: for the flow of a viscous compound (Newtonian fluid) through a tube, the following applies

V′=[π●R⁴(p₁−p₂)]:(8●η●1)

where V′ is the volume flow rate of the compound, R is the tube radius, p₁, is the pressure of the compound at the tube start, P₂ is the pressure of the compound at the tube end, η is the dynamic viscosity (consistency) of the compound and 1 is the length of the tube (see Hering et al.: Physik für Ingenieure [Physics for engineers] page 122, VDI-Verlag, Düsseldorf, 1989). When rewritten, this equation becomes:

η=[π●R⁴(p₁−p₂)]:(8●V′●1).

Herein, R and 1 are constant. Furthermore, p₂ corresponds to the external pressure and can likewise be regarded as constant. If it is assumed that, at least for a certain time, the feed instrument feeds a constant flow rate V′ into the tube, i.e. the die, then the pressure p₁ in the compound depends directly on the viscosity η. If the pressure changes, then this corresponds to a change in the viscosity of the compound and therefore, for example, to averaging of the dough compound.

The friction force F_{R} of the compound is equal to the pressure force F_{P} acting at the tube ends (ibid.):

F_{R}=F_{P}=(p₁−p₂)●π●R².

This means that when the pressure p₁ in the compounded rises, the friction force F_{R} also increases. The pressure p₁ is therefore a measure of the friction force F_{R} of the compound. The friction force F_{R} depends on the flow resistance of the compound in the die and on the shear forces in the compound. As described above, the compound should not be exposed to large shear forces. With the aid of the determined pressure in the compound, it is then possible to limit the friction force on the compound and hence prevent its damage.

According to a further or alternative configuration of the device, the measured variable is the flow rate of the compound. According to the aforementioned equation

η=[π●R⁴(p₁−p₂)]:(8●V′●1),

the viscosity η depends on the pressure p₁and the volume flow rate V′. Through suitable means which limit the pressure p₁, it is possible to keep constant the pressure p₁ prevailing in the die. The viscosity η therefore depends only on the volume flow rate V′ of the compound. The volume flow rate V′ of an incompressible fluid through a tube is

V′=π●R²●vₘ,

where vₘ is the average flow rate, or the exit flow velocity, of the compound. Determining the flow rate of the compound hence makes it possible to determine both the emerging volume flow rate and any change in the viscosity of the compound.

According to an advantageous configuration of the invention, the sensing instrument is coupled to a control instrument, and the control instrument is capable of controlling the feed instrument, as a function of at least one measured value determined by the sensing instrument, in such a way that the exit velocity of the compound from the die is not only substantially constant, but fluctuates minimally. The effect of a uniform exit velocity of the compound is that the bakery or confectionery products which are produced have a uniform shape and weight.

According to the above equations, the following applies:

V′=π●R²●v_{m =[π●R}⁴(p₁−p₂)]:(8●η●1).

The average flow rate or exit velocity vₘ can therefore be adapted by appropriately adapting the volume flow rate V′ or the pressure p₁ in the die by using the feed instrument.

According to an advantageous configuration of the device according to the invention, it comprises a transport instrument for removing the compound extruded from the die, the sensing instrument being coupled to the control instrument, and the control instrument being capable of controlling the transport instrument, as a function of at least one measured value determined by the sensing instrument, in such a way that the transport velocity of the transport instrument corresponds to the exit velocity of the compound from the die.

In the known devices, the transport velocity of the transport instrument is constant, so that a non-uniformly emerging compound, when arriving on the transport instrument, is stretched or compressed by the latter. According to the invention, the exit velocity of the compound and its removal rate are equal, so that a uniformly shaped compound extrudate is obtained.

According to a further advantageous configuration of the invention, the device comprises a rotary instrument having at least one rotatable die, the sensing instrument is operatively coupled to the control instrument, and the control instrument is capable of controlling the rotary instrument, as a function of at least one measured value determined by the sensing instrument, in such a way that the exit velocity of the compound from the die fluctuates minimally.

In the case of a rotatable die, the flow resistance of the die generally fluctuates during the rotation. The friction force F_{R} of the compound therefore changes. According to the above equations, however, it is possible to adapt the flow rate vₘ of the compound as desired, by appropriately adapting the pressure p₁ in the compound by means of the feed instrument. This can be done, according to the invention, by using a control instrument.

In order to obtain bakery products with a plurality of extrudates, a feed instrument is connected through a plurality of channels to a die having a plurality of outlet openings, and a sensing instrument is in each case arranged at the channels or the outlet openings of the die.

The latter device is advantageously adjusted in the following way: the sensing instruments are operatively coupled to the control instrument, and the control instrument is capable of controlling the feed instrument, as a function of the measured values determined by the sensing instruments, in such a way that the exit velocities of the individual compounds from the outlet openings of the die fluctuate minimally relative to one another. By virtue of such uniformly emerging compounds, the layering of the bakery or confectionery products which are made has a constant thickness. The products therefore have an especially high level of dimensional and weight accuracy.

By using the device according to the invention, it is hence possible to make bakery or confectionery products with a much higher level of weight and shape accuracy than is the case with known devices.

The appended schematic drawing shows an exemplary embodiment of the device according to the invention for extruding plastic compounds, which will be explained in more detail below.

A device 10 for extruding plastic compounds comprises a feed instrument 12, which is configured as a roller press and by means of which compounds, for example dough or sugar/fat compounds, can be fed to a die 14. A transport device 16 in the form of a conveyor belt is arranged below the die 14. The emerging compounds pass, shaped into an extrudate, onto the transport instrument 16 and are removed horizontally by it. Bakery products are formed, for example, which are baked in a downstream oven (not shown).

The extrudate may be cut or sealed by a cutting or pinching device (not shown), so that the cut sections of the extrudate are removed on the transport instrument 16. Furthermore, a plurality of dies 14 may be arranged next to one another, so that the capacity of the device is correspondingly enhanced.

For delivering and feeding the compounds, the feed instrument 12 has three pairs of rollers 18a, 20a, 18b, 20b and 18c and 20c which, in a manner which is known and is therefore not described in detail here, receive the compounds from a respective supply line 22a, 22b and 22c. The rollers 18a to 18c and 20a to 20c have, distributed at the circumference, delivery strips which each deliver one compound into a respective pressure space (not shown).

During this, the delivery pressure generated by the delivery strips fluctuates according to the position of the delivery strips in the pressure space. The feed instrument therefore generates an oscillating delivery pressure which, in particular, fluctuates with the delivery rate vₐ, v_{b} and v_{c}. of the individual pairs of rollers.

When the rollers turn, the compounds are delivered with the feed pressure into channels 24a, 24b and 24c, respectively. The compounds reach the die 14, which is designed as a triple die and has three outlet openings (not shown). The outlet openings are arranged in such a way that the emerging compound forms an extrudate (not shown). The die 14 can be rotated with a rotational velocity v_{d} by means of a rotary instrument 26. The die 14 has asymmetrically arranged connection and ring channels (not shown) so that the compounds can flow from the channels 24a to 24c to the outlet openings even when the die 14 is turning. When the die 14 turns, differing flows pass through the individual connection and ring channels, so that the flow resistance of the compounds therefore fluctuates, and in particular this fluctuation oscillates as a function of the rotational velocity v_{d} of the die 14.

The rollers 18a to 18c and 20a to 20c can each be driven by a feed drive, these being operated by separately ventilated electric motors 28a, 28b and 28c, respectively. In this case, a respective temperature sensor 30a, 30b and 30c and hand switch 32a, 32b and 32c for manual operation is arranged at each of the electric motors 28a to 28c. The electrical supplies of the electric motors 28a to 28c are each provided with a respective frequency converter 34a, 34b and 34c and speed regulator 36a, 36b and 36c, by means of which it is possible to vary the rotational speed of the electric motors 28a to 28c and therefore the delivery rates vₐ, v_{b} and v_{c}.

The rotary device 26 has a rotary drive, which can be driven by means of an electric motor 38. A temperature sensor 40 and a hand switch 42 are provided at the electric motor 38. The rotational velocity v_{d} of the electric motor 38 can be adapted by means of a frequency converter 44 and a speed regulator 46.

The transport instrument 16 comprises a transport drive, which can be driven by means of an electric motor 48 with a separately driven fan (not shown), a temperature sensor 50 and a hand switch 52. To regulate the rotational speed of the electric motor 48, and therefore a transport rate vₜ of the conveyor belt, the electric motor 48 has an encoder 54, a frequency converter 56 and a speed regulator 58.

A pressure sensor 60a, 60b and 60c, respectively, is in each case arranged at the channels 24a to 24c, and, as a sensing device, is capable of determining the pressure pₐ, p_{b} or p_{c} of the extruded compounds which prevails in the respective channels 24a to 24c.

The frequency converters 34a, 34b and 34c, 44 and 56, as well as the pressure sensors 60a, 60b and 60c are operatively coupled through lines (only partially shown) to a control instrument 62. The control instrument 62 is configured as a programmable logic circuit and can change the delivery or feed rates vₐ, v_{b} and v_{c}, of the feed instrument 12, the rotational velocity v_{d} of the rotary instrument 26 and the transport rate vₜ of the transport instrument 16 by means of the frequency converters 34a to 34c, 44 and 56, respectively.

In this case, the pressures pₐ, p_{b} and p_{c} determined by the pressure sensors 60a to 60c are processed by the control instrument 62.

According to a first control method, the control instrument 62 in this case adapts the feed rates vₐ, v_{b} and v_{c} in such a way that the pressures pₐ, p_{b} and p_{c} are constant, so that, if the viscosity of the compounds remains the same, their exit velocity fluctuates minimally.

A second control method is configured in such a way that the transport rate vₜ is adjusted to the exit velocity vₛ of the emerging extrudate, so that the extrudate is not stretched or compressed when it arrives on the conveyor belt.

According to a third control method, the rotational velocity v_{d} is adapted to the delivery rate vₐ to v_{c}, so that the fluctuating delivery pressure of the feed instrument 12 and the fluctuating flow resistance of the die 14 compensate for one another. For the revolution of n delivery strips of a roller during the time t, the rotational velocity v_{d} is selected in such a way that the die 14 rotates n times or with a multiple of n.

In a fourth control method, the delivery rates vₐ to v_{c}, are matched to one another in such a way that, depending on the viscosity of the individual compounds, pressures pₐ, p_{b} and p_{c} prevail in the individual channels 24a to 24c such that the exit velocities of the compounds fluctuate only minimally relative to one another.

Alternatively, the pressure sensors 60a to 60c may be configured as flowmeters, the aforementioned control methods being appropriately adapted to the measured variable consisting of the flow rate, so that analogous control results are obtained.

1. Device (10) for extruding plastic compounds, having at least one feed instrument (12) for feeding a compound through a channel (24a; 24b; 24c) to a die (14), a sensing instrument (60a; 60b; 60c) being provided at the channel (24a; 24b; 24c) or at the die (14) in order to determine at least one measured variable (Pₐ; P_{b}; P_{c}) related to the viscosity of the compound, characterised in that
the feed instrument (12) and the die (14) are configured in such a way that the feed instrument (12) has a delivery pressure which oscillates over time at a frequency, and
the die (14) has a flow resistance which oscillates at the same frequency.

2. Device according to claim 1, characterised in that the measured variable is the pressure (pₐ; p_{b}; p_{c}) of the compound.

3. Device according to claim 1 or 2, characterised in that the measured variable is the flow rate of the compound.

4. Device according to claim 1, 2 or 3, characterised in that
the sensing instrument (60a; 60b; 60c) is operatively coupled to a control instrument (62), and
the control instrument (62) is capable of controlling the feed instrument (12), as a function of at least one measured value determined by the sensing instrument (60a; 60b; 60c), in such a way that the exit velocity (vₛ) of the compound from the die (14) fluctuates minimally.

5. Device according to claim 1, 2, 3 or 4, characterised in that
the device (10) comprises a transport instrument (16) for removing the compound extruded from the die (14),
the sensing instrument (60a; 60b; 60c) is operatively coupled to a/the control instrument (62), and
the control instrument (62) is capable of controlling the transport instrument (16), as a function of at least one measured value determined by the sensing instrument (60a; 60b; 60c), in such a way that the transport velocity (vₜ) of the transport instrument (16) corresponds to the exit velocity (vₛ) of the compound from the die (14).

6. Device according to claim 1, 2, 3, 4 or 5, characterised in that
the device (10) comprises a rotary instrument (26) having at least one rotatable die (14),
the sensing instrument (60a; 60b; 60c) is operatively coupled to a/the control instrument (62), and
the control instrument (62) is capable of controlling the rotary instrument (26), as a function of at least one measured value determined by the sensing instrument (60a; 60b; 60c), in such a way that the exit velocity (vₛ) of the compound from the die (14) fluctuates minimally.

7. Device according to claim 1, 2, 3, 4, 5 or 6, characterised in that
a feed instrument (12) is connected through a plurality of channels (24a; 24b; 24c) to a die (14) having a plurality of outlet openings, and
a sensing instrument (60a; 60b; 60c) is in each case arranged at the channels (24a; 24b; 24c) or at the outlet openings of the die (14).

8. Device according to claim 7, characterised in that
the sensing instruments (60a; 60b; 60c) are operatively coupled to a/the control instrument (62), and
the control instrument (62) is capable of controlling the feed instrument (12), as a function of the measured values determined by the sensing instruments (60a; 60b; 60c), in such a way that the exit velocities of the individual compounds from the outlet openings of the die (14) fluctuate minimally relative to one another.
